(19) United States
(12) Patent Application Publication
(10) Pub. No.: US 2011/0188239 A1
(43) Pub. Date: Aug. 4, 2011

(54) ILLUMINATION OF MULTIPLE TYPES OF OBJECTS USING WARM AND COOL LIGHT

(76) Inventors: Eran Plonski, Montreal (CA); Sharath Kumar, Laval (CA); Eihab Baqui, Brossard (CA)

(21) Appl. No.: 12/874,958

(22) Filed: Sep. 2, 2010

Related U.S. Application Data
(63) Continuation of application No. PCT/CA2009/000290, filed on Mar. 11, 2009.
(60) Provisional application No. 61/035,498, filed on Mar. 11, 2008.

(51) Int. Cl. F21S 2/00

(52) U.S. Cl. 362/231

(57) ABSTRACT

There is described a lighting system for illuminating multiple types of objects, the lighting system comprising: at least one first light source emitting a first quantity of a first light characterized by at least one first dominant spectral component corresponding to at least one warm color; and at least one second light source emitting a second quantity of a second light characterized by at least one second dominant spectral component corresponding to at least one cool color; and at least one beam of mixed neutral white light resulting from a mixing of the at least one first light and the at least one second light, the mixed neutral white light having spectral components corresponding to cool colors and spectral components corresponding to warm colors in substantially even proportions, the at least one beam of mixed neutral light being suitable for highlighting substantially evenly at least one cool object and at least one warm object.

### CROSS-REFERENCE TO RELATED APPLICATIONS

The present application claims priority under 35 USC §119(e) of U.S. Provisional Patent Application bearing Ser. No. 61/035,498, filed on Mar. 11, 2008, the contents of which are hereby incorporated by reference.

### TECHNICAL FIELD

The present invention relates to the illumination of multiple types of objects, namely those that are better suited for warm light illumination and those that are better suited for cool light illumination.

### BACKGROUND OF THE INVENTION

In order to present a better appearance, certain objects such as jewels require different kinds of light depending on the type of materials they are made of. While silver and diamonds require a cool white light to appear better, gold and other gems need a warm white light.

The available white lights are usually either cool or warm. As a result, jewels requiring different types of light are usually displayed in different locations under the appropriate cool or warm white light. Furthermore, some jewels are made of a combination of materials that are contrary in their lighting needs, such as gold and diamonds, for example. Placing such jewels under a cool white light illumination favours the appearance of diamonds to the detriment of the appearance of gold. Conversely, placing such jewels under a warm white light, improves the appearance of gold to the detriment of the appearance of diamonds. Therefore there is a need for displaying all kinds of jewels in a same display case without favouring one kind of jewels to the detriment of others.

### SUMMARY OF THE INVENTION

According to a first broad aspect, there is provided a lighting system for illuminating multiple types of objects, the lighting system comprising: at least one first light source emitting a first quantity of a first light characterized by at least one first dominant spectral component corresponding to at least one warm color; and at least one second light source emitting a second quantity of a second light characterized by at least one second dominant spectral component corresponding to at least one cool color; and at least one beam of mixed neutral white light resulting from a mixing of the at least one first light and the at least one second light, the mixed neutral white light having spectral components corresponding to cool colors and spectral components corresponding to warm colors in substantially even proportions, the at least one beam of light being suitable for highlighting substantially evenly at least one cool object and at least one warm object.

According to another aspect, there is provided a method for illuminating multiple types of objects, the method comprising: generating a first light in a first quantity from a first light source, the first light characterized by at least one first dominant spectral component corresponding to at least one warm color; generating a second light in a second quantity from a second light source, the second light characterized by at least one second dominant spectral component corresponding to at least one cool color; and mixing the first light and the second light to obtain a mixed neutral white light, the mixed neutral white light having spectral components corresponding to cool colors and spectral components corresponding to warm colors in substantially even proportions; and illuminating at least one cool object and at least one warm object using the mixed neutral white light to highlight substantially evenly the at least one cool object and the at least one warm object.

The expression “neutral white light source” refers to a light source that emits a white light having a cool light component (i.e. spectral components corresponding to cool colors) and a warm light component (i.e. spectral components corresponding to warm colors) in substantially even proportions. In one embodiment of a neutral white light source, the emitted optical power corresponding to warm colors is substantially equal to the emitted optical power corresponding to warm colors. In another embodiment of a neutral white light, the number of photons corresponding to warm colors is substantially equal to that corresponding to cool colors. A neutral white light may have a temperature color between 3500 and 5000 K.

A cool white light source is a light source emitting cool white light. A cool white light is a light that appears substantially white while having at least one dominant spectral component corresponding to at least one cool color. In a cool white light, the spectral components corresponding to cool colors are more important than the spectral components corresponding to warm colors, in proportion. In a cool white light source, the emitted optical power corresponding to cool colors is superior to the emitted optical power corresponding to warm colors. Blue and green are examples of cool colors. A cool white light may have a temperature color between 5000 and 6500 K.

A warm white light source is a light source emitting warm white light. A warm white light is a light that appears substantially white while having at least one dominant spectral component corresponding to at least one warm color. In a warm white light, the spectral components corresponding to warm colors are more important than the spectral components corresponding to cool colors, in proportion. In a warm white light source, the emitted optical power corresponding to warm colors is superior to the emitted optical power corresponding to cool colors. Red and yellow are examples of warm colors. A warm white light may have a temperature color between 2500 and 4000 K.

A cool color light source is a light source emitting light appearing as a cool color. The frequency (or wavelength) spectrum of cool color light comprises at least one dominant spectral component corresponding to at least one cool color. Alternatively, the spectrum of cool color light can comprise a single component corresponding to a cool color. A blue LED emitting blue light is an example of a cool color light source.

A warm color light source is a light source emitting light appearing as a warm color. The frequency (or wavelength) spectrum of warm color light comprises at least one dominant spectral component corresponding to at least one warm color. Alternatively, the spectrum of cool color light can comprise a single component corresponding to a cool color. A red LED emitting red light is an example of a warm color light source.

The term “cool objects” refers to object, such as jewels, that present a better appearance when illuminated by cool white light. Jewels made of silver and/or containing diamonds are examples of cool objects.

The term “warm objects” refers to objects, such jewels, that present a better appearance when illuminated by warm white light. Golden jewels are examples of warm objects.

### BRIEF DESCRIPTION OF THE DRAWINGS

Further features and advantages of the present invention will become apparent from the following detailed description, taken in combination with the appended drawings, in which:

FIG. 1 is a flow chart of a method of illuminating multiple types of jewels using a cool white light source according to an embodiment;

FIG. 2 illustrates a spectrum of cool white light having one dominant peak, according to an embodiment;

FIG. 3 illustrates a spectrum of cool white light having two dominant peaks, according to an embodiment;

FIG. 4 illustrates a lighting system for illuminating jewels, according to an embodiment;

FIG. 5 illustrates the positioning of a cool light source and a warm light source in a lighting system comprising no mixing optics, in accordance with an embodiment;

FIG. 6 illustrates a lighting system comprising additional mixing optics, according to an embodiment;

FIG. 7 illustrates a circular lighting system, according to an embodiment; and

FIG. 8 is perspective view of a display unit comprising a lighting system, according to an embodiment.

It will be noted that throughout the appended drawings, like features are identified by like reference numerals.

### DETAILED DESCRIPTION

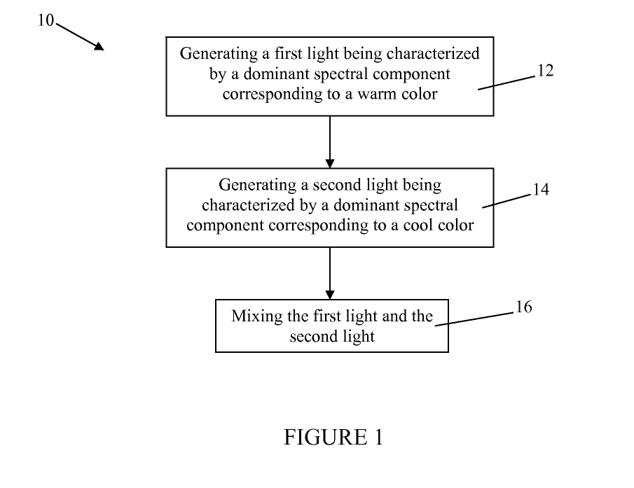

FIG. 1 illustrates a method 10 for illuminating multiple types of objects requiring different types of white lights. The first step 12 consists in generating from a first light source a first light of which the frequency (or wavelength) spectrum comprises a dominant component corresponding to a warm color. The first light is provided in a first quantity. The second step 14 consists in generating a second light from a second light source of which the frequency (or wavelength) spectrum comprises a dominant component corresponding to a cool color. The second light is generated in a second quantity. The last step 18 of the method consists in mixing the generated first light and the generated second light together. The first quantity and the second quantity are chosen so that the mixed light corresponds to a neutral white light. As a result, the neutral white light comprises spectral components corresponding to cool colors, i.e. the cool light component, and spectral components corresponding to warm colors, i.e. the warm light component, in substantially even proportions. The mixed neutral white light ensures a proper appearance for each one of the multiple objects, i.e. the mixed neutral white light allows all objects to be displayed in a favourable light by highlighting all objects substantially evenly.

In one embodiment, the method 10 is used for illuminating objects including warm jewels and cool jewels and the first light is a warm white light while the second light is a cool white light. If the warm white light is only used for illuminating the jewels, the warm jewels would have a better appearance to the detriment of the cool jewels. Conversely, if only the cool white light source is used for illuminating the jewels, then the cool jewels would have a better appearance to the detriment of the warm jewels. By providing the warm white light and the cool white light in appropriate quantities and mixing them, the jewels are illuminated by a neutral white light which is suitable for providing a favourable appearance to both the warm jewels and the cool jewels.

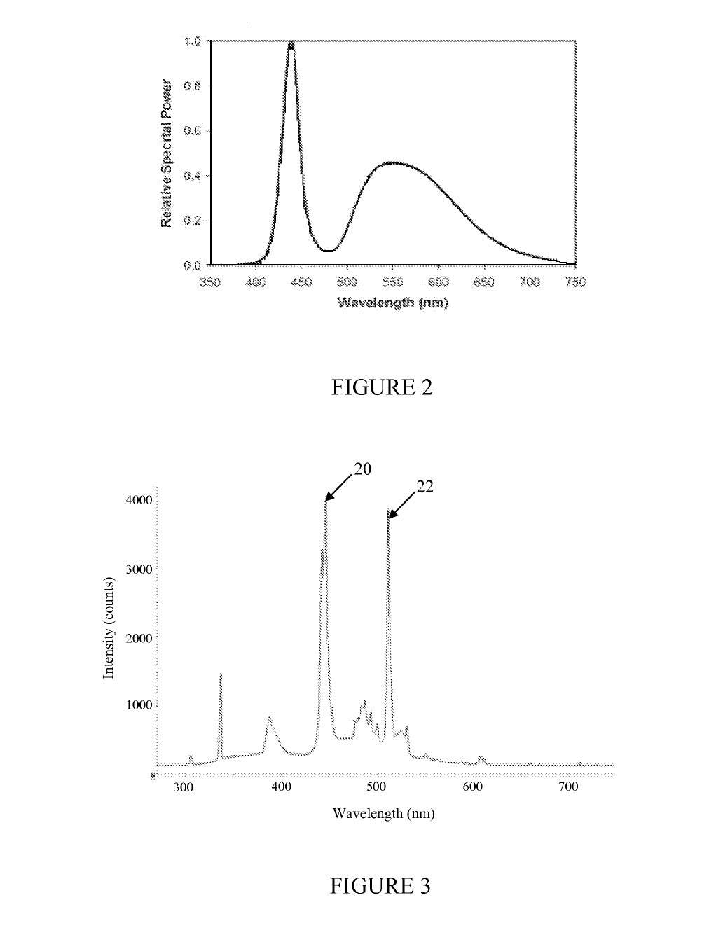

FIG. 2 illustrates a spectrum of a cool white light having one dominant peak, according to an embodiment. The spectrum has a dominant peak around 445 nm which corresponds to blue light. While the light corresponding to this spectrum appears white, blue is dominant. The optical power of cool colors is superior in proportion to that of warm colors.

FIG. 3 illustrates a spectrum of a cool white light having two dominant peaks, according to an embodiment. The first dominant peak 50 is located around 445 nm and corresponds to blue light. The second dominant peak 52 is located around 520 nm and corresponds to green light. The light corresponding to this spectrum is a cool white light having blue and green as dominant colors.

A light having the spectrum illustrated in FIG. 2 or 3 is suitable for illuminating silver and diamonds, for example. However, gold would appear sparkling and a customer could doubt of its quality. By adding in an appropriate quantity and mixing warm white light to the light having the spectrum illustrated in FIG. 2 or 3, a substantially neutral white light is obtained. The neutral white light is suitable for illuminating any type of jewels.

In another embodiment, the first light source emits a warm color light and the second light source emits a cool white light. The warm color light is provided in sufficient quantity to compensate for the lack of warm colors in the cool white light. The mixing of the cool white light and the warm color light results in a substantially neutral white light which means that the cool and warm colors are substantially present in even proportions in the mixed light. For example, a red light or a yellow light provided in an appropriate quantity is mixed with a cool white light.

In a further embodiment, the first light source emits a warm white light and the second light source emits a cool color light. The cool color light is provided in sufficient quantity to compensate for the lack of cool colors in the warm white light. For example, a defined optical power of blue light can be generated to create a substantially neutral white light. The mixing of the warm white light and the cool color light results in a substantially neutral white light which means that the cool and warm colors are substantially present in even proportions in the mixed light. The resulting neutral white light is suitable for illuminating cool jewels, warm jewels and jewels containing materials requiring warm light and materials requiring cool light.

While the description refers to methods of illuminating multiple types of jewels, the same methods can be used to illuminate objects other than jewels. The methods can be used to illuminate multiple types of objects requiring different types of light to present a better appearance. For example, the methods can be used for illuminating clothes, toys, food items, and the like. The dependence of the object on the type of light can be caused by the material of the object and/or its color. For example, the methods can be used to illuminate items placed in a display unit, the items having different colors. While cool colors such as blue require cool light to present a better and more attractive appearance, warm colors such as yellow require warm light. Using the previously described methods, it is possible to illuminate cool color items and warm color items without having an effect on the appearance of any of the items.

In one embodiment, the mixing of the first and second lights is achieved thanks to the relative positioning of the first light source and the second light source. Both light sources are close enough to each other and the illuminated objects are far enough from the two light sources so that the lights emitted by the two light sources mix together before reaching the objects. The resulting white light is substantially neutral and suitable for illuminating all types of jewels. No additional optics are required to achieve the mixing.

In another embodiment, the mixing of the first and second lights is achieved by using mixing optics. The mixing optics allow the beam of the first light to mix with the beam of the second light. Diverting lenses and optical diffusers are example of mixing optics that can be used.

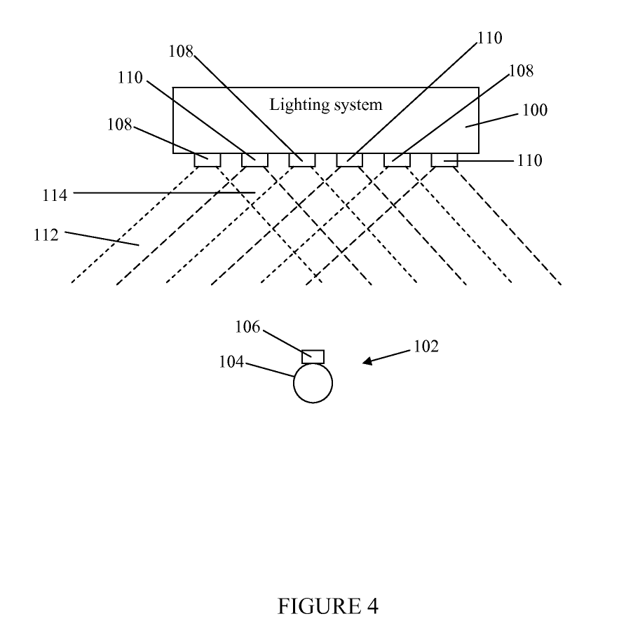

FIG. 4 illustrates one embodiment of a lighting system 100 illuminating a jewel 102. The jewel 102 comprises a golden ring 104 and a diamond 106. While the golden ring 104 requires warm white light to present a better appearance, the diamond 106 requires cool white light. The lighting system 100 comprises cool light sources 108 such as cool white light sources for example, and second warm light sources 110, such as warm white light sources for example, provided alternatively and in series. Each cool white light source 108 emits a beam 112 of cool white light and each warm white light source 114 emits a beam 114 of warm white light. The space between two subsequent white light sources 108, 110, the divergence of the beams 112, 114, and the distance between the jewel 102 and the light sources 108, 110 are adequate for mixing the cool and warm white lights before reaching the jewel 102. As a result, the jewel receives a substantially even proportion of cool and warm white lights since the cool white light and the warm white light are provided in appropriate quantities so that the resulting mixed white light is substantially neutral. In the resulting mixed neutral white light, the warm and cool colors are present in substantially even proportions.

It should be understood that the number of cool white light sources 108 may be different from the number of warm white light sources 110 as long as the optical power of cool components is substantially equal to that of the warm components once the mixing of light is achieved.

In one embodiment, the cool white light sources 108 are replaced by cool color light sources. The cool color light sources emit a cool color light in an appropriate quantity to compensate for the lack of cool colors of the warm white light. In another embodiment, the warm white light sources 110 are substituted by warm color light sources. The warm color light sources emit warm color light in an appropriate quantity to compensate for the lack of warm colors in the cool light sources.

It should be understood that the lighting system 100 can be used to illuminate items other than jewels, such as any kind of objects requiring different types of white light to have a proper appearance.

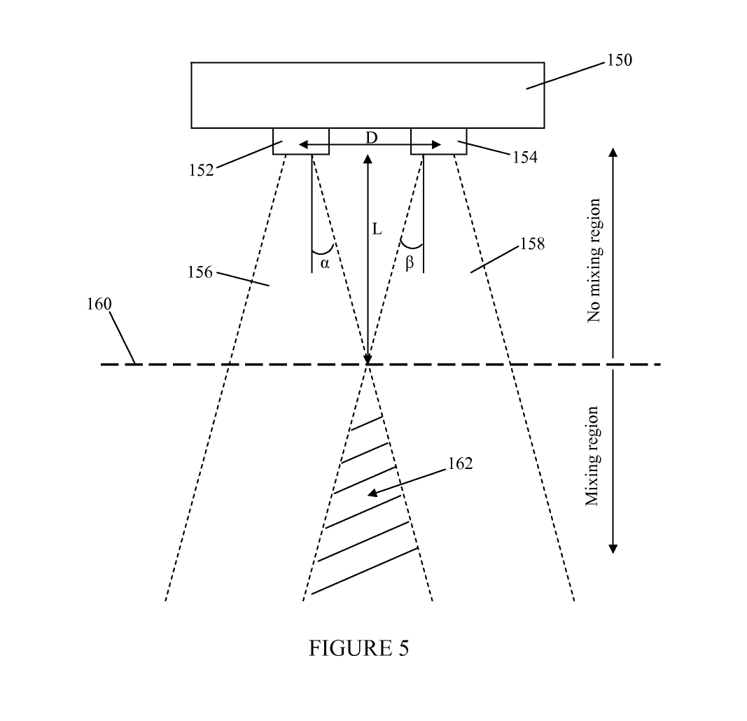

FIG. 5 illustrates the positioning of a warm white light source and a cool white light source to obtain an adequate mixing of light without using mixing optics. A lighting system 150 comprises a cool white light source 152 and a warm white light source 154 which are separated by a distance D. The cool white light source 152 emits a light beam 156 having a divergence angle α while the warm white light source 154 emits a light beam 158 having a divergence angle β. The line 160 located at a distance L from the light sources 152 and 154 defines a border between a non-mixing region and a mixing region. If they are positioned above the line 160, objects will not be illuminated by a neutral white light source since no mixing of light occurs in the non-mixing region. If they are positioned below the line 160 in the dashed region 162 defining the region in which mixing of cool and warm white light occurs, the objects will be illuminated by both the cool white light source 152 and the warm white light source 154 and each object is provided with a proper appearance independently of the type of white light it requires.

While FIG. 5 illustrates the positioning of a cool white light source and a warm white light source for a mixing of light to occur, it should be understood that the same concept applies for the mixing of light emitted by a cool white light source and a warm color light source, and a warm white light source and a cool color light source.

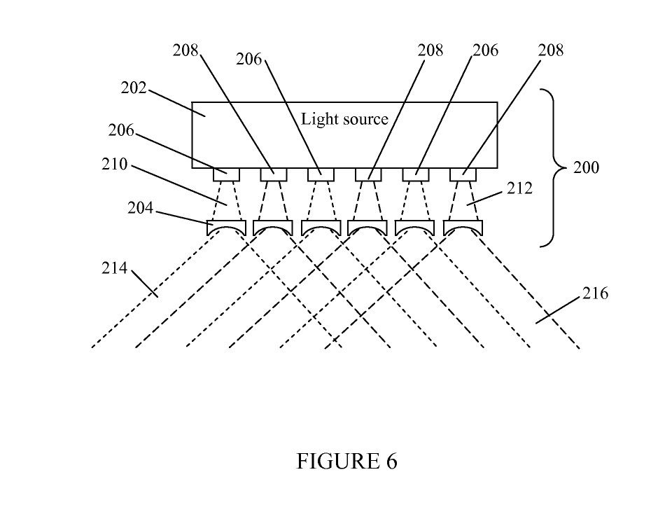

FIG. 6 illustrates one embodiment of a lighting system 200 having mixing optics. The lighting system 200 comprises a light source 202 and a series of divergent lenses 204. The light source 202 includes cool white light sources 206 emitting beams 210 of cool white light and warm white light sources 206 emitting beams 212 of warm white light. The cool and warm white light sources 206, 208 are provided alternatively and in series. The combination of the space between two following white light sources 206, 208 and the divergence of the beams 210, 212 is not adequate for mixing the cool and warm white lights. Consequently, mixing optics comprising divergent lenses 204 are used to mix the cool and warm white lights. One divergent lens 204 is associated with one white light source. The low divergent beams 210 and 212 are transformed into highly divergent beams 214 and 216, respectively, by the divergent lenses. The divergence of the beams 214 and 216 is adequate for mixing the cool white light and the warm white light. This results in a substantially neutral white light which comprises a substantially even proportion of cool and warm white lights.

In one embodiment, a lens 204 is adapted to the type of light source to which it is associated. For example, the beam 210 of cool white light can be less divergent than the beam 212 of warm white light. The lenses 204 are chosen to obtain beams 214 and 216 of substantially even divergence. Alternatively, the divergence of the beams 214 and 216 can be substantially different without affecting the neutral property of the white light resulting from the mixing.

In another embodiment, the system of lenses 204 can be replaced by an optical diffuser in order to achieve the mixing of the cool and warm white lights. It should be understood that any means known by a person skilled in the art for mixing light can be used.

It should be also understood that the cool white light sources 108 and 206 can be replaced by cool color light sources. Alternatively, the warm white light sources 110 and 208 can be replaced by warm color light sources. The cool and warm lights are provided in appropriate quantity to obtain a substantially neutral white light.

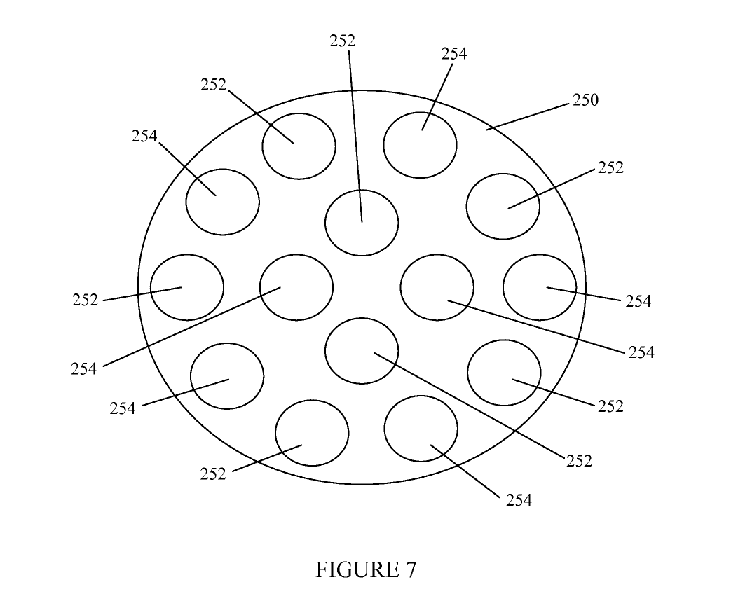

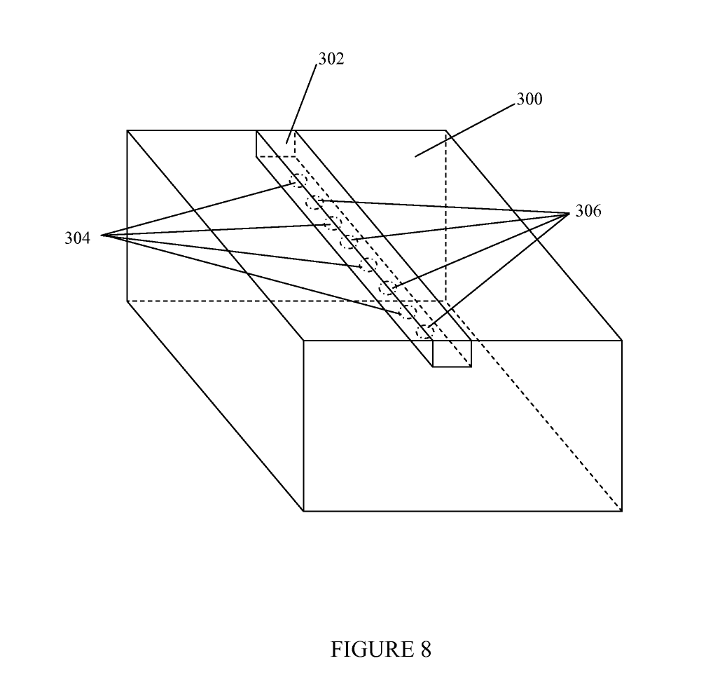

While FIGS. 4 and 6 illustrates cool white light sources and warm white light sources disposed in series, FIG. 7 illustrates one embodiment of a circular lighting system 250. The circular lighting system 250 includes cool light sources 252 and warm light sources 254. The light sources are arranged in concentric circles. For each circle either a cool light source 252 or a warm light source 254 is aligned therewith. This arrangement of cool and warm light sources 252 and 254 ensures a substantially neutral light resulting from the mixing of the light emitted by the cool and warm light sources 252 and 254. Each point illuminated by the light sources of the circular lighting system 250 receives a substantially even proportion of cool and warm light. The lighting system 250 may be provided with additional mixing optics if the arrangement of the cool and warm light sources 252 and 254 and the divergence of the beams emitted by these sources is not adequate for mixing the cool and warm lights.

In one embodiment, the cool light source 252 is a cool white light source and the warm light source 254 is a warm color light source. In another embodiment, the cool light source 252 is a cool color light source and the warm light source 254 is a warm white light source. Alternatively, the cool light source 252 is a cool white light source and the warm light source 254 is a warm white light source.

In one embodiment, the cool light sources 252 and the warm light sources 254 are arranged substantially randomly in the lighting system 250. This results in an emitted light which is substantially neutral. It should be understood that any spatial arrangement of cool and warm light sources can be used as long as the beams of cool and warm light mix together and result in a substantially neutral white light.

While FIG. 6 illustrates a light source 250 provided with an even number of cool light sources 252 and warm light sources 254, it should be understood that the light source 250 could be provided with a different number of cool and warm light sources as long as the mixing of their beams result in substantially neutral white light.

FIG. 8 illustrates one embodiment of a display unit 300 comprising a neutral white light source 302. The display unit 300 can be used to display any type of jewels, i.e. cool jewels, warm jewels and jewels made of materials requiring both cool light and warm light. The white light source 302 comprises cool light sources 304 and warm light sources 306. The lights emitted by the cool light sources 304 and the warm light sources 306 mix to result in a substantially neutral white light suitable for illumination of any type of jewels. If the mixing of the cool and warm lights is not adequate, the neutral light source can be provided with additional mixing optics.

The display unit 300 can be used to display items or objects requiring cool and warm lights. For example, the display unit 300 can be refrigerated to display fresh or frozen food. The packaging of food usually presents intense and varied colors to attract the customers' attention. However, if a single type of light (warm or cool) is used, some items will have a better appearance than others. The display unit 300 allows any displayed item to have an improved appearance by emitting a substantially neutral light.

It should be understood that the warm white light sources, the cool white light sources and the cool/warm color light sources can be LED lighting sources and/or non-LED lighting sources. The cool/warm color light can obtained from a white light which is filtered to obtain the desired color. For example, the lighting system can comprise a cool fluorescent white light lamp and a plurality of red LEDs. The emitted optical power of the fluorescent lamp and the red LEDs, and the number and the spatial location of the red LEDs are chosen so that the resulting mixed light is substantially neutral. In another example, the neutral light source is constituted of a warm incandescent white light source and a plurality of cool LEDs, such as blue LEDs. The emitted optical power of the incandescent light source and the blue LEDs, and the number and the spatial location of the blue LEDs are chosen so that the resulting mixed light is substantially neutral. In a further example, a neutral light source may comprise one or more cool white light LED and one or more red LED.

The embodiments of the invention described above are intended to be exemplary only. The scope of the invention is therefore intended to be limited solely by the scope of the appended claims.

1. A lighting system for illuminating multiple types of objects, said lighting system comprising:
at least one first light source emitting a first quantity of a first light characterized by at least one first dominant spectral component corresponding to at least one warm color; and
at least one second light source emitting a second quantity of a second light characterized by at least one second dominant spectral component corresponding to at least one cool color; and
at least one beam of mixed neutral white light resulting from a mixing of said at least one first light and said at least one second light, said mixed neutral white light having spectral components corresponding to cool colors and spectral components corresponding to warm colors in substantially even proportions, said at least one beam of light being suitable for highlighting substantially evenly at least one cool object and at least one warm object.

2. The lighting system as claimed in claim 1, wherein said at least one first light source is a warm white light source.

3. The lighting system as claimed in claim 2, wherein said at least one second light source is a cool white light source.

4. The lighting system as claimed in claim 2, wherein said at least one second light source is a cool color light source.

5. The lighting system as claimed in claim 1, wherein said at least one second light source is a cool white light source.

6. The lighting system as claimed in claim 5, wherein said at least one first light source is a warm white light source.

7. The lighting system as claimed in claim 5, wherein said at least one first light source is a warm color light source.

8. The lighting system as claimed in claim 1, further comprising mixing optics for mixing light beams emitted by said at least one first light source and said at least one second light source to produce said mixed neutral white light.

9. The lighting system as claimed in claim 1, wherein said at least one first light source and said at least one second light source comprises a series of alternating first and second light sources.

10. The lighting system as claimed in claim 1, wherein said at least one first light source and said at least one second light source comprises a circular arrangement of a plurality of first light sources and second lights sources.

11. The lighting system as claimed in claim 10, wherein said plurality of first light sources and second light sources are randomly distributed in said circular arrangement.

12. The lighting system as claimed in claim 10, wherein said plurality of first light sources and second light sources are alternatingly distributed in said circular arrangement.

13. A method for illuminating multiple types of objects, said method comprising:
generating a first light in a first quantity from a first light source, said first light characterized by at least one first dominant spectral component corresponding to at least one warm color;
generating a second light in a second quantity from a second light source, said second light characterized by at least one second dominant spectral component corresponding to at least one cool color; and
mixing said first light and said second light to obtain a mixed neutral white light, said mixed neutral white light having spectral components corresponding to cool colors and spectral components corresponding to warm colors in substantially even proportions; and
illuminating at least one cool object and at least one warm object using said mixed neutral white light to highlight substantially evenly said at least one cool object and said at least one warm object.

14. The method as claimed in claim 13, wherein said generating said first light comprises generating a warm white light.

15. The method as claimed in claim 14, wherein said generating said second light comprises generating a cool white light.

16. The method as claimed in claim 14, wherein said generating said second light comprises generating a cool color light.

17. The method as claimed in claim 13, wherein said generating said second light comprises generating a cool white light.

18. The method as claimed in claim 17, wherein said generating said first light comprises generating a warm white light.

19. The method as claimed in claim 17, wherein said generating said first light comprises generating a warm color light.

20. The method as claimed in claim 13, wherein said mixing said first light and said second light comprises spatially positioning said first light source and said second light source so that beams of light generated by said first light source and said second light source mix together.

21. (canceled)
